(19) United States
(12) Patent Application Publication
(10) Pub. No.: US 2025/0193786 A1
(43) Pub. Date: Jun. 12, 2025

(54) PERIODIC HIGHER-PRIORITY PLMN SEARCH FOR SATELLITE ACCESS IN MOBILE COMMUNICATIONS

(71) Applicant: MediaTek Singapore Pte. Ltd., Singapore (SG)

(72) Inventors: Marko NIEMI, Oulu (FI); Yuan-Chieh LIN, Hsinchu City (TW)

(21) Appl. No.: 18/846,563

(22) PCT Filed: Mar. 29, 2023
(86) PCT No.: PCT/CN2023/084669

§ 371 Date: Sep. 12, 2024

Related U.S. Application Data
(60) Provisional application No. 63/329,510, filed on Apr. 11, 2022.

(51) Int. Cl. H04W 48/18; H04W 48/16; H04W 84/04; H04W 84/06

(52) U.S. Cl. CPC H04W 48/18; H04W 48/16; H04W 84/042; H04W 84/06

(57) ABSTRACT

Examples pertaining to a periodic higher priority public land mobile network (PLMN) search for satellite access in mobile communications are described. A user equipment (UE) determines that, regarding a satellite access to a network, a selected PLMN (SPLMN) or a registered PLMN (RPLMN) is not a home PLMN (HPLMN), an equivalent HPLMN (EHPLMN) or a highest-priority PLMN at a location in which the UE is located. Then, in response to the determining, the UE performs a PLMN search during a period of discontinuous coverage (DC) of the SPLMN or RPLMN.

### CROSS REFERENCE TO RELATED PATENT APPLICATION(S)

The present disclosure is part of a non-provisional application claiming the priority benefit of U.S. Patent Application No. 63/329,510, filed 11 Apr. 2022, the content of which herein being incorporated by reference in its entirety.

### TECHNICAL FIELD

The present disclosure is generally related to mobile communications and, more particularly, to a periodic higher-priority public land mobile network (PLMN) search for satellite access in mobile communications.

### BACKGROUND

Unless otherwise indicated herein, approaches described in this section are not prior art to the claims listed below and are not admitted as prior art by inclusion in this section.

In Internet-of-Things (IoT) non-terrestrial network (NTN) systems, a user equipment (UE) may be subject to discontinuous coverage (DC) with respect to satellite access such that, for example, the UE may be in coverage of a satellite-accessing cell for 10 minutes in every 4 hours. Typically, the UE may utilize the satellite access (e.g., satellite Evolved Universal Mobile Telecommunications System (UMTS) Terrestrial Radio Access Network (E-UTRAN) in an Evolved Packet System (EPS) or satellite next-generation radio access network (NG-RAN) in a 5^{th} Generation System (5GS)) to obtain service(s) from a PLMN, and the access may provide DC. In case that the UE knows how the satellite cell coverage (e.g., for home PLMN (HPLMN)) varies in time (e.g., from ephemeris data broadcast by a satellite-accessing cell from which the UE gains access) then, upon determining a time when DC starts or is about to start, the UE may deactivate its Access Stratum (AS) functionality in order to optimize or otherwise minimize power consumption until coverage is back. Tracking area or radio access technology (RAT)-specific Mobility Management Element (MME) configuration may be used to support UEs using a RAN that provides DC (e.g., for satellite access with DC). For example, in case that a satellite system only provides coverage to a UE for 10 minutes in every 4 hours when a satellite passes the geolocation of the UE, the MME could configure a periodic tracking area update (TAU) timer and a mobile reachable timer for the UE to be just greater than 10 minutes as well as configure a Implicit Detach timer to be greater than 4 hours. However, there is a possibility that the UE may stay connected to a lower-priority PLMN when its HPLMN is also available in the UE's present location. Therefore, there is a need for a solution of a periodic higher-priority PLMN search for satellite access in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is propose schemes, concepts, designs, systems, methods and apparatus pertaining to a periodic higher-priority PLMN search for satellite access in mobile communications. It is believed that the above-described issue would be avoided or otherwise alleviated by implementing one or more of the proposed schemes described herein.

In one aspect, a method may involve a processor of an apparatus (e.g., UE) determining that, regarding a satellite access to a network, a selected PLMN (SPLMN) or a registered PLMN (RPLMN) is not a home PLMN (HPLMN), an equivalent HPLMN (EHPLMN) or a highest-priority PLMN at a location in which the UE is located. In response to the determining, the method may also involve the processor performing a PLMN search during a period of DC of the SPLMN or RPLMN.

In another aspect, an apparatus may include a transceiver and a processor coupled to the transceiver. The transceiver may be configured to communicate wirelessly with a network. The processor may determine that, regarding a satellite access to the network, a SPLMN or a RPLMN is not a HPLMN, an EHPLMN or a highest-priority PLMN at a location in which the UE is located. In response to the determining, the processor may also perform, via the transceiver, a PLMN search during a period of DC of the SPLMN or RPLMN.

It is noteworthy that, although description provided herein may be in the context of certain radio access technologies, networks and network topologies such as 5^{th} Generation System (5GS) and 4G Evolved Packet System (EPS) mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), Evolved UTRAN (E-UTRAN), Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a diagram of an example scenario in accordance with an implementation of the present disclosure.

FIG. 3 is a diagram of an example scenario in accordance with an implementation of the present disclosure.

FIG. 4 is a diagram of an example scenario in which various proposed schemes in accordance with the present disclosure may be implemented.

FIG. 5 is a block diagram of an example communication system in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to a periodic higher-priority PLMN search for satellite access in mobile communications. According to the present disclosure, a number of possible solutions may be implemented separately or jointly. That is, although these possible solutions may be described below separately, two or more of these possible solutions may be implemented in one combination or another.

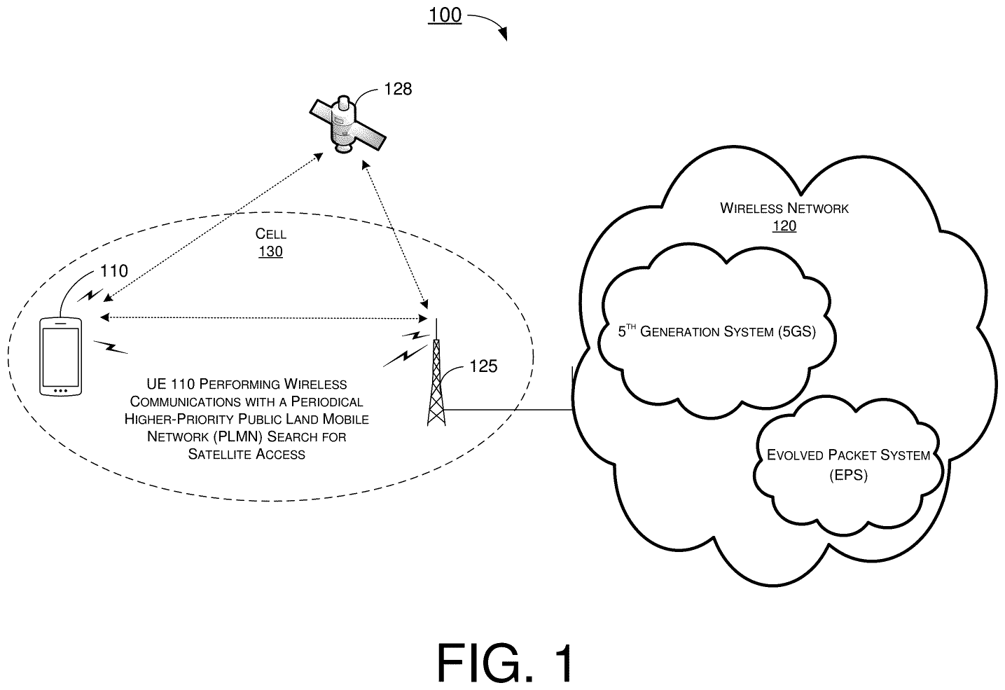

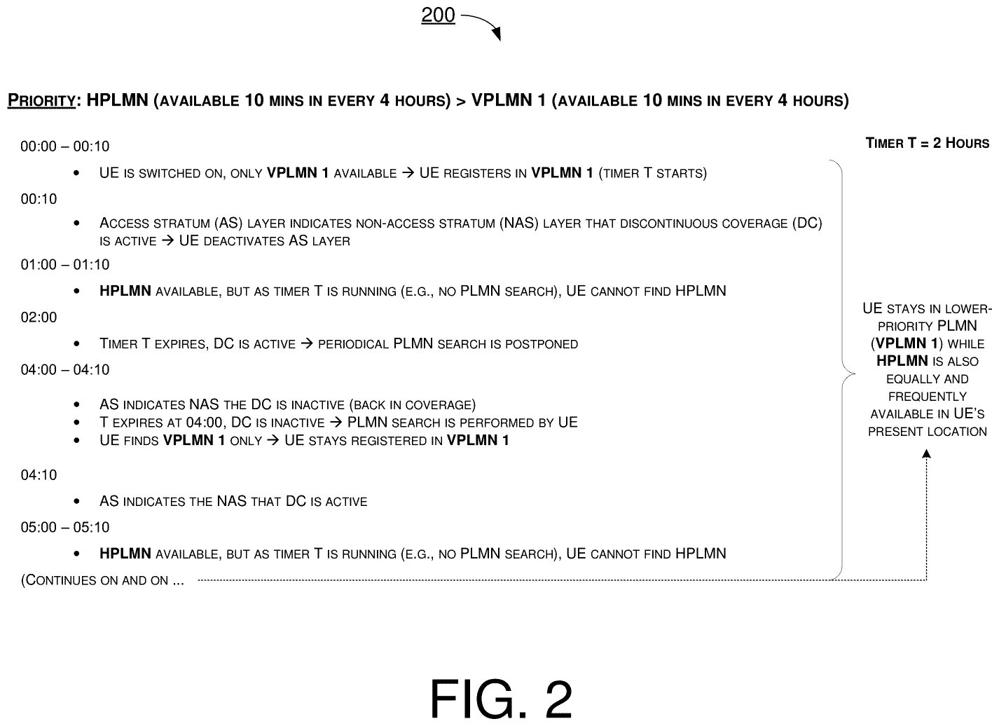

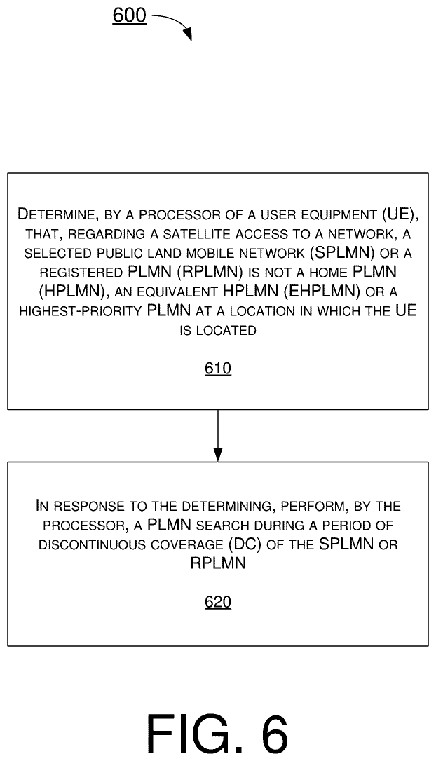

FIG. 1 illustrates an example network environment 100 in which various solutions and schemes in accordance with the present disclosure may be implemented. FIG. 2˜FIG. 6 illustrate examples of implementation of various proposed schemes in network environment 100 in accordance with the present disclosure. The following description of various proposed schemes is provided with reference to FIG. 1˜FIG. 6.

Referring to FIG. 1, network environment 100 may involve a UE 110 and a wireless network 120, which may include a 5GS and/or an EPS. Depending on channel condition, availability and/or other factor(s), UE 110 may be in wireless communication with wireless network 120 via one or more terrestrial network nodes (e.g., base station(s) such as eNB, gNB and/or transmission/reception point (TRP)) and/or one or more non-terrestrial network nodes (e.g., satellite(s)). For simplicity in illustration and without limiting the scope of the present disclosure, UE 110 may be associated with or otherwise in communication with a cell 130 corresponding to a terrestrial network node 125 (e.g., gNB, eNB or TRP) and/or a non-terrestrial network node 128 (e.g., satellite) of wireless network 120. In network environment 100, UE 110 and wireless network 120 may implement various schemes pertaining to a periodic higher-priority PLMN search for satellite access in mobile communications in accordance with the present disclosure, as described below. It is noteworthy that, while the various proposed schemes may be individually or separately described below, in actual implementations each of the proposed schemes may be utilized individually or separately. Alternatively, some or all of the proposed schemes may be utilized jointly.

FIG. 2 illustrates an example scenario 200 in accordance with an implementation of the present disclosure. In scenario 200, UE 110 may perform a higher-priority PLMN search to find a highest-priority PLMN at a location in which UE 110 is located. Moreover, in scenario 200, a priority of a home PLMN (HPLMN) of UE 110 may be higher than the priority of a first visited PLMN (VPLMN 1). Additionally, a timer T used by UE 110, as a periodic PLMN selection timer, may be configured or otherwise set by a home operator to a value of 2 hours. Furthermore, in scenario 200, each of HPLMN and VPLMN 1 may be available for 10 minutes in every 4 hours.

Referring to FIG. 2, during the time of 00:00-00:10, UE 110 may be switched on while only VPLMN 1 is available, and thus UE 110 may be registered in VPLMN 1 and start timer T. At time 00:10, an access stratum (AS) layer may indicate to a non-access stratum (NAS) layer that DC is active, and thus UE 110 may deactivate its AS layer. During the time of 01:00-01:10, HPLMN may become available but, as T is still running (meaning no PLMN search is to be performed), UE 110 may not be able to find HPLMN. At time 02:00, timer T expires and DC is active, and thus a periodic PLMN search may be postponed. During the time of 04:00-04:10, the AS layer indicates to the NAS layer that DC is inactive, meaning UE 110 is back in coverage. Also, at time 04:00, timer T expires and DC is inactive, and thus the PLMN search may be performed. However, as UE 110 may only find VPLMN 1, UE 110 may stay registered in VPLMN 1. At time 04:10, the AS layer indicates to the NAS layer that DC is active. During the time of 05:00-05:10, HPLMN may become available but, as timer T is running (meaning no PLMN search is to be performed), UE 110 may not be able to find HPLMN. The aforementioned steps, stages or operations may be repeated continuously. However, UE 110 may stay registered in a lower-priority PLMN (e.g., VPLMN 1) while a higher/highest-priority PLMN (e.g., HPLMN) may be also equally frequently available in the present location of UE 110.

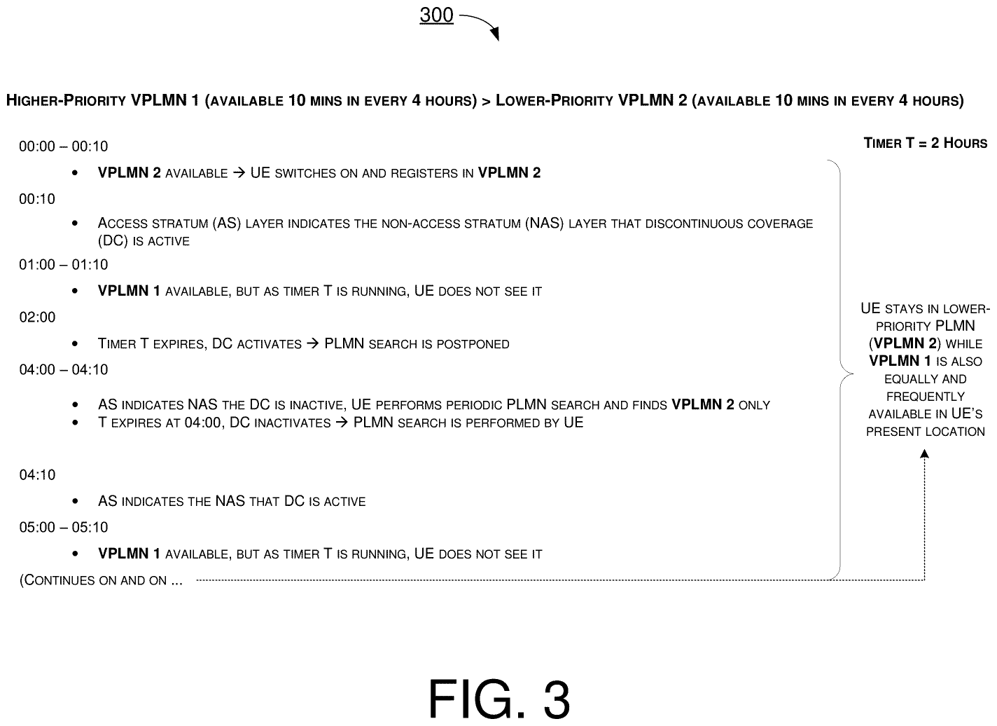

FIG. 3 illustrates an example scenario 300 in accordance with an implementation of the present disclosure. In scenario 300, UE 110 may perform a higher-priority PLMN search to find a highest-priority PLMN at a location in which UE 110 is located. Moreover, in scenario 300, a priority of a first visited PLMN (VPLMN 1) of UE 110 may be higher than the priority of a second visited PLMN (VPLMN 2). Additionally, a timer T used by UE 110, as a periodic PLMN selection timer, may be configured or otherwise set by a home operator to a value of 2 hours. Furthermore, in scenario 300, each of VPLMN 1 and VPLMN 2 may be available for 10 minutes in every 4 hours.

Referring to FIG. 3, during the time of 00:00-00:10, UE 110 may be switched on while only VPLMN 1 is available, and thus UE 110 may be registered in VPLMN 1 and start timer T. At time 00:10, an AS layer may indicate to a NAS layer that DC is active, and thus UE 110 may deactivate its AS layer. During the time of 01:00-01:10, the HPLMN of UE 110 may become available but, as T is still running (meaning no PLMN search is to be performed), UE 110 may not be able to find HPLMN. At time 02:00, timer T expires and DC is active, and thus a periodic PLMN search may be postponed. During the time of 04:00-04:10, the AS layer indicates to the NAS layer that DC is inactive. Also, at time 04:00, timer T expires and DC is inactive, and thus the PLMN search may be performed. Although UE 110 may perform periodic PLMN search, UE 110 may only find VPLMN 2. At time 04:10, the AS layer indicates to the NAS layer that DC is active. During the time of 05:00-05:10, VPLMN 1 may become available but, as timer T is running (meaning no PLMN search is to be performed), UE 110 may not be able to find VPLMN 1. The aforementioned steps, stages or operations may be repeated continuously. However, UE 110 may stay registered in a lower-priority PLMN (e.g., VPLMN 2) while a higher-priority PLMN (e.g., VPLMN 2) may be also equally frequently available in the present location of UE 110.

Under a first proposed scheme in accordance with the present disclosure, UE 110 may determine that a selected PLMN (SPLMN) or a registered PLMN (RPLMN) is not an equivalent HPLMN (EHPLMN) or the highest-priority PLMN at the present location of UE 110 (e.g., a country or an international area where UE 110 is currently located), yet UE 110 may not postpone its periodic PLMN search even during the DC (when DC is active). It is noteworthy that a RPLMN is a PLMN on which UE 110 has performed a location registration successfully by tracking area update (TAU). The RPLMN may be the highest-priority PLMN available at a time when UE 110 performs the PLMN search or selection (although the RPLMN is still not the highest-priority PLMN in the country/location of the present location of UE 110). Under the proposed scheme, UE 110 may determine the priority of PLMNs based on information configured in an “Operator Controlled PLMN Selector with Access Technology” list. Alternatively, or additionally, UE 110 may determine the priority of PLMNs based on information configured in a user-controlled PLMN selector. Alternatively, or additionally, UE 110 may determine the priority of PLMNs based on information configured in a Management Element (ME) or a Universal Subscriber Identity Module (USIM).

Under a second proposed scheme in accordance with the present disclosure, UE 110 may determine that the current RPLMN is not the highest-priority PLMN (nor EHPLMN) while UE 110 may be capable of satellite E-UTRAN and/or NG-RAN access (whether DC is active or inactive), and UE 110 may perform a periodic PLMN search in more frequent cycles than in conventional implementations. For instance, in case that timer T is set at 2 hours, the periodic PLMN search may be performed by UE 110 every 1 hour.

Under a third proposed scheme in accordance with the present disclosure, UE 110 may have a new configuration (e.g., configuration management object (MO) or a USIM configuration) for a shorter PLMN search duration for satellite access. For instance, the new configuration may be under the control of a home operator or network 120 (e.g., for steering of a roaming mechanism used to control UE 110).

Under a fourth proposed scheme in accordance with the present disclosure, UE 110 may use stored information and/or history (e.g., UE 110 being previous registered to a PLMN and having stored broadcast information in a memory of UE 110), such as ephemeris data of the PLMN, to trigger a PLMN search with knowledge of when a higher-priority PLMN should appear. That is, UE 110 may trigger the PLMN search at a time when the higher-priority PLMN is supposed to appear (based on stored information and/or history).

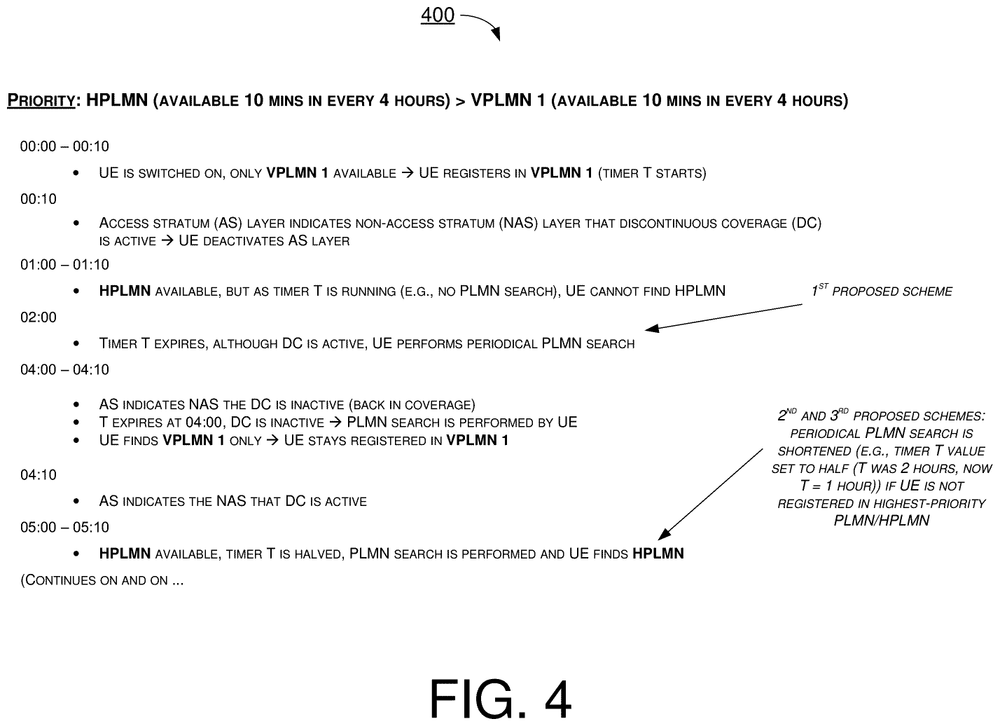

FIG. 4 illustrates an example scenario 400 in which various proposed schemes in accordance with the present disclosure may be implemented. In scenario 400, UE 110 may perform a higher-priority PLMN search to find a highest-priority PLMN at a location in which UE 110 is located. Moreover, in scenario 400, a priority of a HPLMN of UE 110 may be higher than the priority of a VPLMN 1. Additionally, a timer T used by UE 110, as a periodic PLMN selection timer, may be configured or otherwise set by a home operator to a value of 2 hours. Furthermore, in scenario 400, each of HPLMN and VPLMN 1 may be available for 10 minutes in every 4 hours.

Referring to FIG. 4, during the time of 00:00-00:10, UE 110 may be switched on while only VPLMN 1 is available, and thus UE 110 may be registered in VPLMN 1 and start timer T. At time 00:10, an AS layer may indicate to a NAS layer that DC is active, and thus UE 110 may deactivate its AS layer. At time 02:00, timer T expires and DC is active, and UE 110 may perform a periodic PLMN search even though DC is active (according to the first proposed scheme described above). During the time of 04:00-04:10, the AS layer indicates to the NAS layer that DC is inactive, meaning UE 110 is back in coverage. Also, at time 04:00, timer T expires and DC is inactive, and thus a PLMN search may be performed. However, as UE 110 may only find VPLMN 1, UE 110 may stay registered in VPLMN 1. At time 04:10, the AS layer indicates to the NAS layer that DC is active. During the time of 05:00-05:10, HPLMN may become available and, as the runtime of timer T may be halved (according to the second proposed scheme described above), UE 110 may perform a PLMN search and find HPLMN (according to the third proposed scheme descried above). The aforementioned steps, stages or operations may be repeated continuously. Advantageously, UE 110 may find the higher-priority HPLMN and be registered the HPLMN (as opposed to VPLMN 1).

### Illustrative Implementations

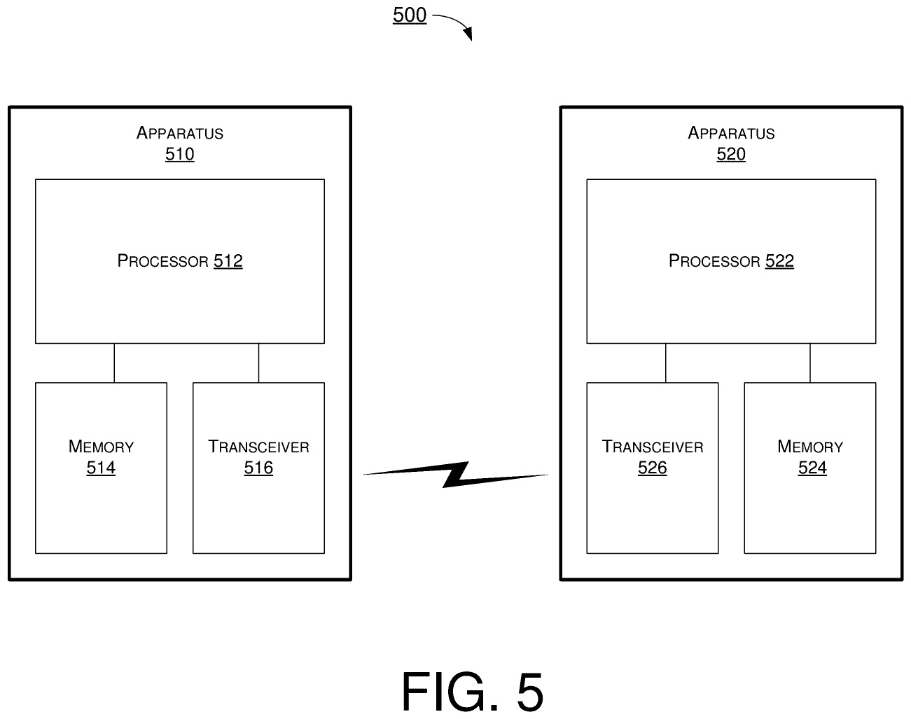

FIG. 5 illustrates an example communication system 500 having at least an example apparatus 510 and an example apparatus 520 in accordance with an implementation of the present disclosure. Each of apparatus 510 and apparatus 520 may perform various functions to implement schemes, techniques, processes and methods described herein pertaining to a periodic higher-priority PLMN search for satellite access in mobile communications, including the various schemes described above with respect to various proposed designs, concepts, schemes, systems and methods described above, including network environment 100, as well as processes described below.

Each of apparatus 510 and apparatus 520 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 510 and apparatus 520 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 510 and apparatus 520 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 510 and apparatus 520 may be implemented in a smart thermostat, a smart fridge, a smart door lock, a wireless speaker or a home control center. When implemented in or as a network apparatus, apparatus 510 and/or apparatus 520 may be implemented in an eNodeB in an LTE, LTE-Advanced or LTE-Advanced Pro network or in a gNB or TRP in a 5G network, an NR network or an IoT network.

In some implementations, each of apparatus 510 and apparatus 520 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 510 and apparatus 520 may be implemented in or as a network apparatus or a UE. Each of apparatus 510 and apparatus 520 may include at least some of those components shown in FIG. 5 such as a processor 512 and a processor 522, respectively, for example. Each of apparatus 510 and apparatus 520 may further include one or more other components not pertinent to the proposed scheme of the present disclosure (e.g., internal power supply, display device and/or user interface device), and, thus, such component(s) of apparatus 510 and apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC or RISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including those pertaining to a periodic higher-priority PLMN search for satellite access in mobile communications in accordance with various implementations of the present disclosure.

In some implementations, apparatus 510 may also include a transceiver 516 coupled to processor 512. Transceiver 516 may be capable of wirelessly transmitting and receiving data. In some implementations, transceiver 516 may be capable of wirelessly communicating with different types of wireless networks of different radio access technologies (RATs). In some implementations, transceiver 516 may be equipped with a plurality of antenna ports (not shown) such as, for example, four antenna ports. That is, transceiver 516 may be equipped with multiple transmit antennas and multiple receive antennas for multiple-input multiple-output (MIMO) wireless communications. In some implementations, apparatus 520 may also include a transceiver 526 coupled to processor 522. Transceiver 526 may include a transceiver capable of wirelessly transmitting and receiving data. In some implementations, transceiver 526 may be capable of wirelessly communicating with different types of UEs/wireless networks of different RATs. In some implementations, transceiver 526 may be equipped with a plurality of antenna ports (not shown) such as, for example, four antenna ports. That is, transceiver 526 may be equipped with multiple transmit antennas and multiple receive antennas for MIMO wireless communications.

In some implementations, apparatus 510 may further include a memory 514 coupled to processor 512 and capable of being accessed by processor 512 and storing data therein. In some implementations, apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory. Alternatively, or additionally, each of memory 514 and memory 524 may include a UICC.

Each of apparatus 510 and apparatus 520 may be a communication entity capable of communicating with each other using various proposed schemes in accordance with the present disclosure. For illustrative purposes and without limitation, a description of capabilities of apparatus 510, as a UE (e.g., UE 110), and apparatus 520, as a network node (e.g., terrestrial network node 125 or non-terrestrial network node 128) of a wireless network (e.g., wireless network 120), is provided below.

Under certain proposed schemes in accordance with the present disclosure with respect to a periodic higher-priority PLMN search for satellite access in mobile communications, processor 512 of apparatus 510, implemented in or as UE 110, may determine that, regarding a satellite access to a network (e.g., wireless network 120), a SPLMN or a RPLMN is not a HPLMN, an EHPLMN or a highest-priority PLMN at a location in which apparatus 510 is located. Moreover, in response to the determining, processor 512 may perform, via transceiver 516, a PLMN search during a period of DC of the SPLMN or RPLMN.

In some implementations, the SPLMN or RPLMN may be a highest-priority PLMN available at a time when apparatus 510 performed a PLMN selection previously but the SPLMN or RPLMN is not the highest-priority PLMN at the location in which apparatus 510 is located.

In some implementations, in determining, processor 512 may determine a priority of each of one or more PLMNs based on information configured in an Operator Controlled PLMN Selector with Access Technology list. Alternatively, or additionally, in determining, processor 512 may determine a priority of each of one or more PLMNs based on information configured in user-controlled PLMN selector. Alternatively, or additionally, in determining, processor 512 may determine a priority of each of one or more PLMNs based on information configured in memory 514 of apparatus 510 or a USIM associated with apparatus 510.

In some implementations, in performing the PLMN search, processor 512 may perform a periodic PLMN search in a higher frequency that is greater than a normal frequency associated with the periodic PLMN search. In such cases, apparatus 510 may be capable of satellite access via either or both of an E-UTRAN and a NG-RAN with DC being active or inactive. In some implementations, a cycle of performing the periodic PLMN search under the higher frequency may be one half or a fraction of that under the normal frequency.

In some implementations, in performing the PLMN search, processor 512 may perform the PLMN search based on a MO or a USIM configuration received from the network.

In some implementations, in performing the PLMN search, processor 512 may perform the PLMN search based on a stored information (e.g., stored in memory 514) from one or more previously registered PLMNs at least one of which having a higher priority than the SPLMN or the registered PLMN, such that the PLMN search is performed during appearance of the at least one of the one or more previously registered PLMNs. In some implementations, the stored information may include ephemeris data of the one or more previously registered PLMNs.

### Illustrative Processes

FIG. 6 illustrates an example process 600 in accordance with an implementation of the present disclosure. Process 600 may represent an aspect of implementing various proposed designs, concepts, schemes, systems and methods described above, whether partially or entirely, including those described above. More specifically, process 600 may represent an aspect of the proposed concepts and schemes pertaining to a periodic higher-priority PLMN search for satellite access in mobile communications. Process 600 may include one or more operations, actions, or functions as illustrated by one or more of blocks 610 and 620. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively in a different order. Furthermore, one or more of the blocks/sub-blocks of process 600 may be executed iteratively. Process 600 may be implemented by or in apparatus 510 and apparatus 520 as well as any variations thereof. Solely for illustrative purposes and without limiting the scope, process 600 is described below in the context of apparatus 510 as a UE (e.g., UE 110) and apparatus 520 as a communication entity such as a network node or base station (e.g., terrestrial network node 125 or non-terrestrial network node 128) of a network (e.g., wireless network 120). Process 600 may begin at block 610.

At 610, process 600 may involve processor 512 of apparatus 510, implemented in or as UE 110, determining that, regarding a satellite access to a network (e.g., wireless network 120) a SPLMN or a RPLMN is not a HPLMN, an EHPLMN or a highest-priority PLMN at a location in which apparatus 510 is located. Process 600 may proceed from 610 to 620.

At 620, in response to the determining, process 600 may involve processor 512 performing, via transceiver 516, a PLMN search during a period of DC of SPLMN or RPLMN.

In some implementations, the SPLMN or RPLMN may be a highest-priority PLMN available at a time when apparatus 510 performed a PLMN selection previously but the SPLMN or RPLMN is not the highest-priority PLMN at the location in which apparatus 510 is located.

In some implementations, in determining, process 600 may involve processor 512 determining a priority of each of one or more PLMNs based on information configured in an Operator Controlled PLMN Selector with Access Technology list. Alternatively, or additionally, in determining, process 600 may involve processor 512 determining a priority of each of one or more PLMNs based on information configured in user-controlled PLMN selector. Alternatively, or additionally, in determining, process 600 may involve processor 512 determining a priority of each of one or more PLMNs based on information configured in memory 514 of apparatus 510 or a USIM associated with apparatus 510.

In some implementations, in performing the PLMN search, process 600 may involve processor 512 performing a periodic PLMN search in a higher frequency that is greater than a normal frequency associated with the periodic PLMN search. In such cases, apparatus 510 may be capable of satellite access via either or both of an E-UTRAN and a NG-RAN with DC being active or inactive. In some implementations, a cycle of performing the periodic PLMN search under the higher frequency may be one half or a fraction of that under the normal frequency.

In some implementations, in performing the PLMN search, process 600 may involve processor 512 performing the PLMN search based on a MO or a USIM configuration received from the network.

In some implementations, in performing the PLMN search, process 600 may involve processor 512 performing the PLMN search based on a stored information (e.g., stored in memory 514) from one or more previously registered PLMNs at least one of which having a higher priority than the SPLMN or the registered PLMN, such that the PLMN search is performed during appearance of the at least one of the one or more previously registered PLMNs. In some implementations, the stored information may include ephemeris data of the one or more previously registered PLMNs.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of a user equipment (UE), that, regarding a satellite access to a network, a selected public land mobile network (SPLMN) or a registered PLMN (RPLMN) is not a home PLMN (HPLMN), an equivalent HPLMN (EHPLMN) or a highest-priority PLMN at a location in which the UE is located; and
in response to the determining, performing, by the processor, a PLMN search during a period of discontinuous coverage (DC) of the SPLMN or RPLMN.

2. The method of claim 1, wherein the SPLMN or RPLMN was a highest-priority PLMN available at a time when the UE performed a PLMN selection previously but the SPLMN or RPLMN is not the highest-priority PLMN at the location in which the UE is located.

3. The method of claim 1, wherein the determining comprises determining a priority of each of one or more PLMNs based on information configured in an Operator Controlled PLMN Selector with Access Technology list.

4. The method of claim 1, wherein the determining comprises determining a priority of each of one or more PLMNs based on information configured in user-controlled PLMN selector.

5. The method of claim 1, wherein the determining comprises determining a priority of each of one or more PLMNs based on information configured in a memory of the UE or a Universal Subscriber Identity Module (USIM) associated with the UE.

6. The method of claim 1, wherein the performing of the PLMN search comprises performing a periodic PLMN search in a higher frequency that is greater than a normal frequency associated with the periodic PLMN search, and wherein the UE is capable of satellite access via either or both of an Evolved Universal Mobile Telecommunications Systems (UMTS) Terrestrial Radio Access (E-UTRAN) and a next-generation radio access network (NG-RAN) with DC being active or inactive.

7. The method of claim 6, wherein a cycle of performing the periodic PLMN search under the higher frequency is one half or a fraction of that under the normal frequency.

8. The method of claim 1, wherein the performing of the PLMN search comprises performing the PLMN search based on a management object (MO) or a Universal Subscriber Identity Module (USIM) configuration received from the network.

9. The method of claim 1, wherein the performing of the PLMN search comprises performing the PLMN search based on a stored information from one or more previously registered PLMNs at least one of which having a higher priority than the selected PLMN or the registered PLMN, such that the PLMN search is performed during appearance of the at least one of the one or more previously registered PLMNs.

10. The method of claim 9, wherein the stored information comprises ephemeris data of the one or more previously registered PLMNs.

11. An apparatus implementable in a user equipment (UE), comprising:
a transceiver configured to communicate wirelessly with a network; and
a processor coupled to the transceiver and configured to perform operations comprising:
determining that, regarding a satellite access to the network, a selected public land mobile network (SPLMN) or a registered PLMN (RPLMN) is not a home PLMN (HPLMN), an equivalent HPLMN (EHPLMN) or a highest-priority PLMN at a location in which the UE is located; and
in response to the determining, performing, via the transceiver, a PLMN search during a period of discontinuous coverage (DC) of the SPLMN or RPLMN.

12. The apparatus of claim 11, wherein the SPLMN or RPLMN was a highest-priority PLMN available at a time when the UE performed a PLMN selection previously but the SPLMN or RPLMN is not the highest-priority PLMN at the location in which the UE is located.

13. The apparatus of claim 11, wherein the determining comprises determining a priority of each of one or more PLMNs based on information configured in an Operator Controlled PLMN Selector with Access Technology list.

14. The apparatus of claim 11, wherein the determining comprises determining a priority of each of one or more PLMNs based on information configured in user-controlled PLMN selector.

15. The apparatus of claim 11, wherein the determining comprises determining a priority of each of one or more PLMNs based on information configured in a memory of the UE or a Universal Subscriber Identity Module (USIM) associated with the UE.

16. The apparatus of claim 11, wherein the performing of the PLMN search comprises performing a periodic PLMN search in a higher frequency that is greater than a normal frequency associated with the periodic PLMN search, and wherein the UE is capable of satellite access via either or both of an Evolved Universal Mobile Telecommunications Systems (UMTS) Terrestrial Radio Access (E-UTRAN) and a next-generation radio access network (NG-RAN) with DC being active or inactive.

17. The apparatus of claim 16, wherein a cycle of performing the periodic PLMN search under the higher frequency is one half or a fraction of that under the normal frequency.

18. The apparatus of claim 11, wherein the performing of the PLMN search comprises performing the PLMN search based on a management object (MO) or a Universal Subscriber Identity Module (USIM) configuration received from the network.

19. The apparatus of claim 11, wherein the performing of the PLMN search comprises performing the PLMN search based on a stored information from one or more previously registered PLMNs at least one of which having a higher priority than the selected PLMN or the registered PLMN, such that the PLMN search is performed during appearance of the at least one of the one or more previously registered PLMNs.

20. The apparatus of claim 19, wherein the stored information comprises ephemeris data of the one or more previously registered PLMNs.
